(19) United States
(12) Patent Application Publication
(10) Pub. No.: US 2026/0150038 A1
(43) Pub. Date: May 28, 2026

(54) COMMUNICATION SYSTEM AND COMMUNICATION METHOD FOR UNMANNED DEVICE

(71) Applicant: Coretronic Intelligent Robotics Corporation, Hsin-Chu (TW)

(72) Inventors: Hsien-Yi Huang, Hsin-Chu (TW); Kuo-Sheng Chung, Hsin-Chu (TW); Kai-Hung Chang, Hsin-Chu (TW); Jih-Shin Ho, Hsin-Chu (TW); Kai-Chung Chan, Hsin-Chu (TW)

(73) Assignee: Coretronic Intelligent Robotics Corporation, Hsin-Chu (TW)

(21) Appl. No.: 19/401,366

(22) Filed: Nov. 26, 2025

Related U.S. Application Data
(60) Provisional application No. 63/724,907, filed on Nov. 26, 2024.

(30) Foreign Application Priority Data
Mar. 5, 2025 (TW) 114108208

(51) Int. Cl. H04W 48/18; H04W 24/08; H04W 84/06

(52) U.S. Cl. CPC H04W 48/18; H04W 24/08; H04W 84/06

(57) ABSTRACT

A communication system and a communication method for an unmanned device are provided. The communication method includes: communicatively connecting a controller to an unmanned device; respectively transmitting, by the controller, a controller command to a first link and a second link for transmitting a first packet and a second packet including the controller command to the unmanned device through the first link and the second link respectively; selecting a selected packet from the first packet and the second packet, and obtaining the controller command from the selected packet by the unmanned device; and selecting a selected link from the first link and the second link, and transmitting data to the controller through the selected link by the unmanned device. The communication system and the communication method for the disclosure may operate the unmanned device by transmitting commands through multiple links.

### CROSS-REFERENCE TO RELATED APPLICATION

This application claims the priority benefit of U.S. provisional application Ser. No. 63/724,907, filed on Nov. 26, 2024, and Taiwan application serial no. 114108208, filed on Mar. 5, 2025. The entirety of each of the above-mentioned patent application is hereby incorporated by reference herein and made a part of this specification.

### BACKGROUND

### Technical Field

The disclosure relates to a wireless communication technology, and particularly relates to a communication system and a communication method for an unmanned device.

### Description of Related Art

The communication link between an unmanned device (for example, drone, unmanned vehicle or unmanned aerial vehicle) and a remote control device typically uses a single transmission path for communication. For example, uplink data and/or downlink data can be transmitted through mobile networks or industrial, scientific, and medical (ISM) frequency bands. The uplink data may include control commands from the remote control device, while the downlink data may include real-time status information of the unmanned device or data obtained by the unmanned device (for example, captured image data). However, when this single communication link is disconnected or its quality deteriorates due to environmental interference, signal attenuation, or other factors, data transmission may not proceed smoothly (for example, data transmission may be delayed). This may prevent the unmanned device from receiving control commands in real time, thereby affecting the operation of the unmanned device. Especially during flight or driving, if control commands may not be obtained in real time, the unmanned device may experience abnormal movement, or even risks of collision or crash. Therefore, the control method for unmanned devices relying on a single communication link in the existing technology still faces challenges in stability and security.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

A communication system for an unmanned device of the disclosure includes an unmanned device and a controller. The controller is communicatively connected to the unmanned device. The controller respectively transmits a controller command to a first link and a second link for transmitting a first packet and a second packet including the controller command to the unmanned device through the first link and the second link respectively. The unmanned device selects a selected packet from the first packet and the second packet, and obtains the controller command from the selected packet. The unmanned device selects a selected link from the first link and the second link, and the unmanned device transmits data to the controller through the selected link.

A communication method for an unmanned device of the disclosure, including: communicatively connecting a controller to an unmanned device; respectively transmitting, by the controller, a controller command to a first link and a second link for transmitting a first packet and a second packet including the controller command to the unmanned device through the first link and the second link respectively; selecting a selected packet from the first packet and the second packet, and obtaining the controller command from the selected packet by the unmanned device; and selecting a selected link from the first link and the second link, and transmitting data to the controller through the selected link by the unmanned device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a communication system according to an embodiment of the disclosure.

FIG. 2 is a schematic diagram of a multi-link architecture of a communication system according to an embodiment of the disclosure.

FIG. 3 is a flowchart of link selection based on priority mode according to an embodiment of the disclosure.

FIG. 4 is a flowchart of link selection based on backup mode according to an embodiment of the disclosure.

FIG. 5 is a flowchart of link validity detection according to an embodiment of the disclosure.

FIG. 6 is a flowchart of a communication method for an unmanned device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

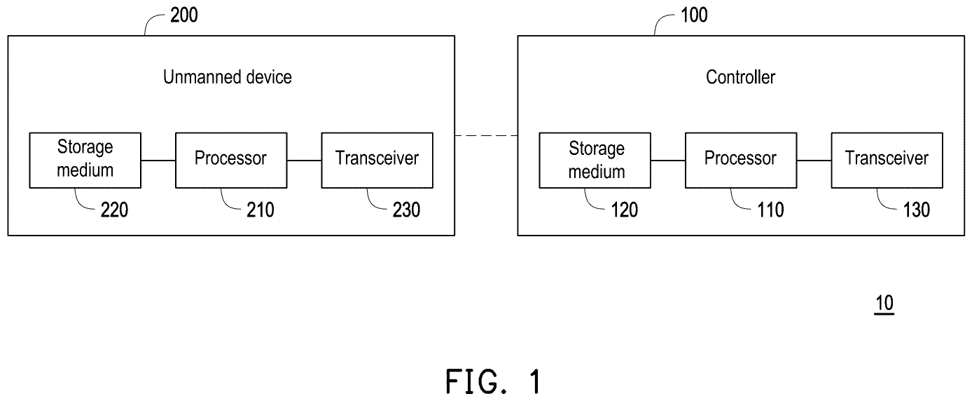

FIG. 1 is a schematic diagram of a communication system 10 according to an embodiment of the disclosure. The communication system 10 may include a controller 100 and an unmanned device 200 communicatively connected to the controller 100. The controller 100 may include a processor 110, a storage medium 120, and a transceiver 130. The unmanned device 200 may include a processor 210, a storage medium 220, and a transceiver 230. The controller 100 is, for example, a remote controller. The unmanned device 200 is, for example, an unmanned vehicle or an unmanned aerial vehicle.

The processor 110 is, for example, a central processing unit (CPU), other programmable general purpose or specific purpose micro control units (MCU), microprocessors, digital signal processors (DSP), programmable controllers, application specific integrated circuits (ASIC), graphics processing units (GPU), image signal processors (ISP), image processing units (IPU), arithmetic logic units (ALU), complex programmable logic devices (CPLD), field programmable gate arrays (FPGA), other similar elements, or a combination of the above elements. The processor 110 may be coupled to the storage medium 120 and the transceiver 130, and access and execute multiple modules and various application programs stored in the storage medium 120.

The storage medium 120 is, for example, any form of fixed or movable random access memory (RAM), a read-only memory (ROM), a flash memory, a hard disk drive (HDD), a solid state drive (SSD), a similar element, or a combination of the above elements, and is used for storing multiple modules or various application programs that may be executed by the processor 110. In an embodiment, the storage medium may store multiple modules including an application layer and a remote interface manager, the functions of which will be described subsequently.

The transceiver 130 transmits or receives signals in a wireless or wired method. The transceiver 130 may also perform operations such as low-noise amplification, impedance matching, mixing, up or down frequency conversion, filtering, amplification, and similar operations. The processor 110 may be communicatively connected to the unmanned device 200 through the transceiver 130.

The processor 210 is, for example, a CPU, other programmable general purpose or specific purpose MCUs, microprocessors, DSPs, programmable controllers, ASICs, GPUs, ISPs, IPUs, ALUs, CPLDs, FPGAs, other similar elements, or a combination of the above elements. The processor 210 may be coupled to the storage medium 220 and the transceiver 230, and access and execute multiple modules and various application programs stored in the storage medium 220.

The storage medium 220 is, for example, any form of fixed or movable RAM, a ROM, a flash memory, a HDD, an SSD, a similar element, or a combination of the above elements, and is used for storing multiple modules or various application programs that may be executed by the processor 210. In an embodiment, the storage medium may store multiple modules including an application layer or a device interface manager, the functions of which will be described subsequently.

The transceiver 230 transmits or receives signals in a wireless or wired method. The transceiver 230 may also perform operations such as low-noise amplification, impedance matching, mixing, up or down frequency conversion, filtering, amplification, and similar operations. The processor 210 may be communicatively connected to the controller 100 through the transceiver 230.

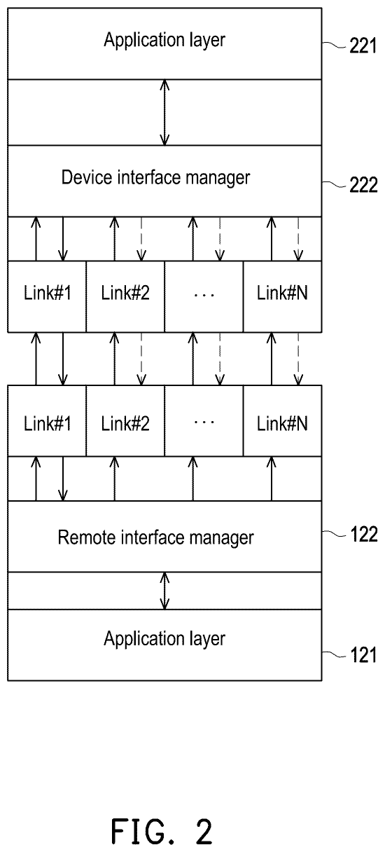

FIG. 2 is a schematic diagram of a multi-link architecture of a communication system 10 according to an embodiment of the disclosure. The transceiver 130 of the controller 100 and the transceiver 230 of the unmanned device 200 may communicate through multiple links, for example through N links (such as link #1, link #2, . . . , link #N), where N may be any positive integer greater than 1. In an embodiment, different links may correspond to different network cards or medium access control (MAC) addresses. For example, the transceiver 130 (or the transceiver 230) may include multiple network cards, and may establish link #1, link #2, . . . , link #N respectively through the multiple network cards (as shown in FIG. 2, link #1, link #2, . . . , link #N are exemplified to indicate the corresponding ports of each link at the transceiver 130 and the transceiver 230). Each of the above links may be a long term evolution (LTE) link, a 2.4 GHz link, or a 5 GHz link, but the disclosure is not limited thereto. In an embodiment, the N links are exemplified as all links that may communicate between the controller 100 and the unmanned device 200 (excluding failed links).

Specifically, when the controller 100 wants to transmit a controller command (for example, a command for directing the unmanned device to move in a specific direction) to the unmanned device 200, an application layer 121 of the controller 100 may instruct a remote interface manager 122 (software or firmware) of the controller 100 to transmit the controller command to the unmanned device 200. The remote interface manager 122 may respectively transmit packets including the same controller command to link #1 to link #N through the transceiver 130. For example, the remote interface manager 122 may broadcast the packets to link #1 to link #N.

A device interface manager 222 (software or firmware) of the unmanned device 200 may respectively receive N packets from link #1 to link #N through the transceiver 230. The device interface manager 222 may select one of the N packets as a selected packet. In an embodiment, the device interface manager 222 may for example first determine the correctness of each packet in the N packets (for example whether the verification code is correct), and then select one packet from the correct packets as the selected packet. The selection order may, for example, be sorted by link number, signal strength, signal transmission speed, or signal-to-noise ratio, but the disclosure is not limited thereto. The device interface manager 222 may assign a virtual MAC address corresponding to the controller 100 to the selected packet, and upload the selected packet with the virtual MAC address to an application layer 221 of the unmanned device 200. The application layer 221 may obtain the controller command from the selected packet (e.g., the unmanned device 200 may obtain the controller command only from the selected packet), thereby operating the unmanned device 200 according to the controller command. The application layer 221 may determine that the source of the selected packet is the controller 100 according to the virtual MAC address of the selected packet. By the method of assigning a virtual MAC address to the selected packet, when it is necessary to select packets from different links, the application layer 221 does not need to re-authenticate the data source, thereby reducing the time delay in obtaining the controller command.

On the other hand, the data transmitted from the unmanned device 200 to the controller 100 has a larger data volume, and if multiple links are used to transmit data, it may consume too many communication resources or computing resources. In order to avoid waste of communication resources or computing resources, the unmanned device 200 may select M links from link #1 to link #N as selected links, and transmit downlink data to the controller 100 through the selected links, where M may be a positive integer less than N and greater than or equal to 1. Links that are not selected may not transmit any downlink data. For example, after the device interface manager 222 receives a command from the application layer 221 to transmit data, the device interface manager 222 may transmit data to the controller 100 through link #1 as the selected link. After the transceiver 130 receives the data transmitted by the unmanned device 200 from link #1, the remote interface manager 122 may transmit the data received from link #1 to the application layer 121. The above-mentioned data may for example include information such as the real-time status of the unmanned device 200 or multimedia data obtained by the unmanned device 200.

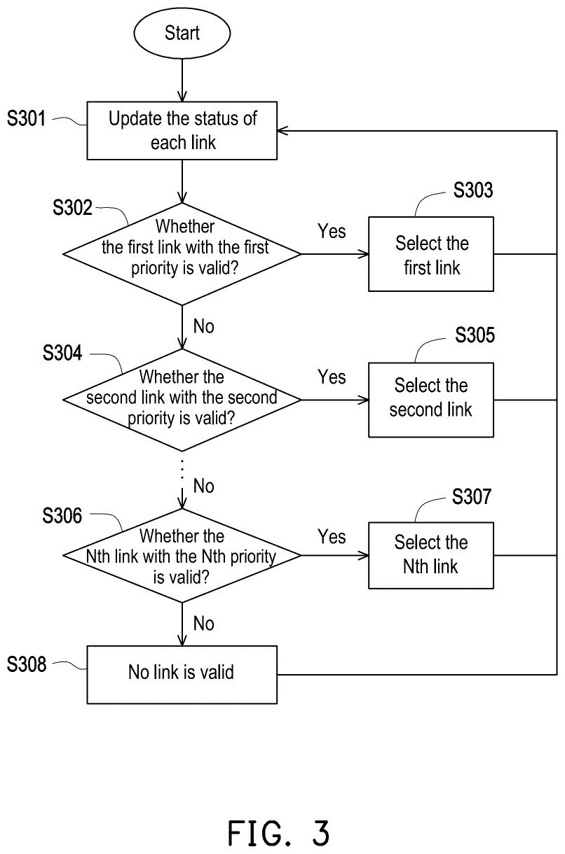

In an embodiment, the device interface manager 222 may determine the selected link according to the priority of each link. The priority order may, for example, be sorted by link number, signal strength, signal transmission speed, or signal-to-noise ratio, but the disclosure is not limited thereto. FIG. 3 is a flowchart of link selection based on priority mode according to an embodiment of the disclosure.

In step S301, the unmanned device 200 (e.g., the device interface manager 222) may update the status of each link, where the status of the link may indicate whether the link is valid.

In step S302, the unmanned device 200 (e.g., the device interface manager 222) may determine whether the first priority of the first link is higher than the priority of other links. If the first priority of the first link is higher than the priority of other links, it means that the first priority is the highest priority. Accordingly, the device interface manager 222 may determine whether the first link with the first priority (i.e., the highest priority) is valid. If the first link is valid, then step S303 is performed. If the first link is invalid, then step S302 is performed.

In step S303, the unmanned device 200 (e.g., the device interface manager 222) may select the first link as the selected link.

In step S304, the unmanned device 200 (e.g., the device interface manager 222) may determine whether the second priority of the second link is higher than the priority of other links except the first link. If the second priority is higher than the priority of other links, it means that the second priority is the second highest priority. Accordingly, the device interface manager 222 may determine whether the second link with the second priority (i.e., the second highest priority) is valid. If the second link is valid, then step S305 is performed. If the second link is invalid, then step S306 is performed.

In step S305, the unmanned device 200 (e.g., the device interface manager 222) may select the second link as the selected link.

After (N−1) links have been determined to be invalid, in step S306, the unmanned device 200 (e.g., the device interface manager 222) may determine whether the Nth link with the Nth priority (i.e., the lowest priority) is valid. If the Nth link is valid, then step S307 is performed. If the Nth link is invalid, then step S308 is performed.

In step S307, the unmanned device 200 (e.g., the device interface manager 222) may select the Nth link as the selected link.

In step S308, the unmanned device 200 (e.g., the device interface manager 222) may determine that no link is valid. Accordingly, the device interface manager 222 may not determine the selected link.

After performing step S303, S305, S307, or S308, step S301 is performed, so that the status of each link may be continuously updated, and the selected link may be preferentially selected as the valid link with higher priority. For example, in an embodiment, when the first link is invalid, and the process proceeds to step S305 to select the second link as the selected link, step S301 will be performed again. If at this time the first link has been restored to valid (step S302), step S303 is performed to select the first link as the selected link, so that the selected link may be timely switched to the link with higher priority.

In another embodiment, the unmanned device 200 (e.g., the device interface manager 222) may prioritize whether the currently used link (for example, the current selected link, or the default link when starting the system) may continue to serve as the selected link. For example, if the current selected link is valid, the device interface manager 222 may maintain the current selected link as the selected link. If the current selected link is invalid, the device interface manager 222 may sequentially select or randomly select other unused valid links as the selected link.

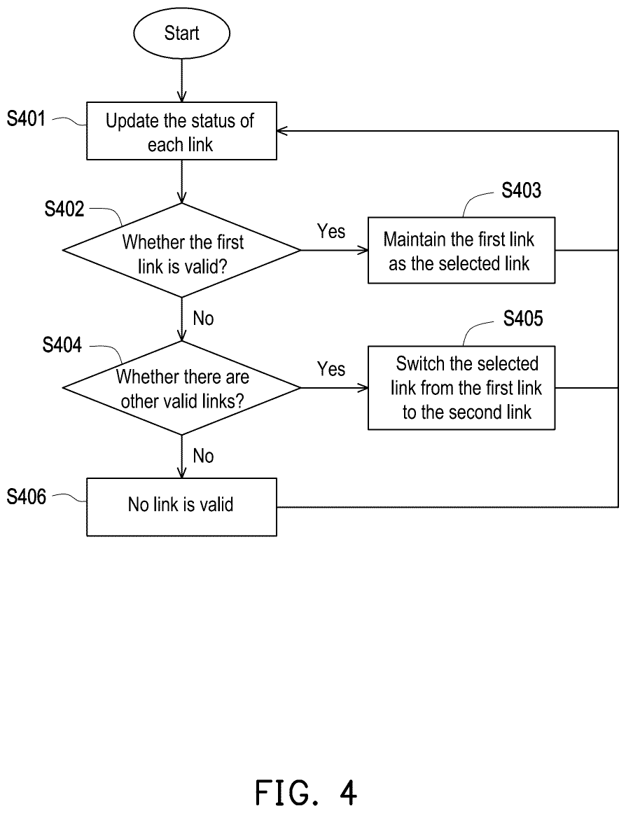

For example, FIG. 4 is a flowchart of link selection based on backup mode according to an embodiment of the disclosure. Assume the first link is the current selected link. In step S401, the unmanned device 200 (e.g., the device interface manager 222) may update the status of each link, where the status of the link may indicate whether each link is valid.

In step S402, the unmanned device 200 (e.g., the device interface manager 222) may determine whether the first link is valid. If the first link is valid, then step S403 is performed. If the first link is invalid, then step S402 is performed.

In step S403, the unmanned device 200 (e.g., the device interface manager 222) may maintain the first link as the selected link.

In step S404, the unmanned device 200 (e.g., the device interface manager 222) may determine whether there are other valid links (for example, a second link different from the first link). If there are other valid links, then step S405 is performed. If there are no other valid links, then step S406 is performed.

In step S405, the unmanned device 200 (e.g., the device interface manager 222) may switch the selected link from the first link to other valid links (for example, the second link). For example, the device interface manager 222 may sequentially select (sort by link number, signal strength, signal transmission speed, or signal-to-noise ratio) or randomly select other unused valid links as the selected link.

In step S406, the unmanned device 200 (e.g., the device interface manager 222) may determine that no link is valid. Accordingly, the device interface manager 222 may not determine the selected link.

After executing step S403, S405, or S406, step S401 is performed, so that the status of each link may be continuously updated, and the selected link may be timely switched to other valid links, and when the selected link is valid, it continues to serve as the selected link, so as to maintain the stability of link communication.

It is particularly noted that, in an embodiment, the device interface manager 222 may determine whether a specific link is valid by transmitting a monitoring message and receiving a response message. For example, the unmanned device 200 may transmit a monitoring message to the controller 100 through a specific link, and receive a response message corresponding to the monitoring message from the controller 100. The device interface manager 222 may determine whether the specific link is valid according to the response message. For example, if the device interface manager 222 receives the response message within a preset period after the monitoring message is transmitted, then the device interface manager 222 may determine that the specific link is valid. If the device interface manager 222 does not receive the response message within the preset period after the monitoring message is transmitted, then the device interface manager 222 may determine that the specific link is invalid. The device interface manager 222 may periodically perform the above steps (i.e., transmitting the monitoring message or receiving the response message) to update the status of each link.

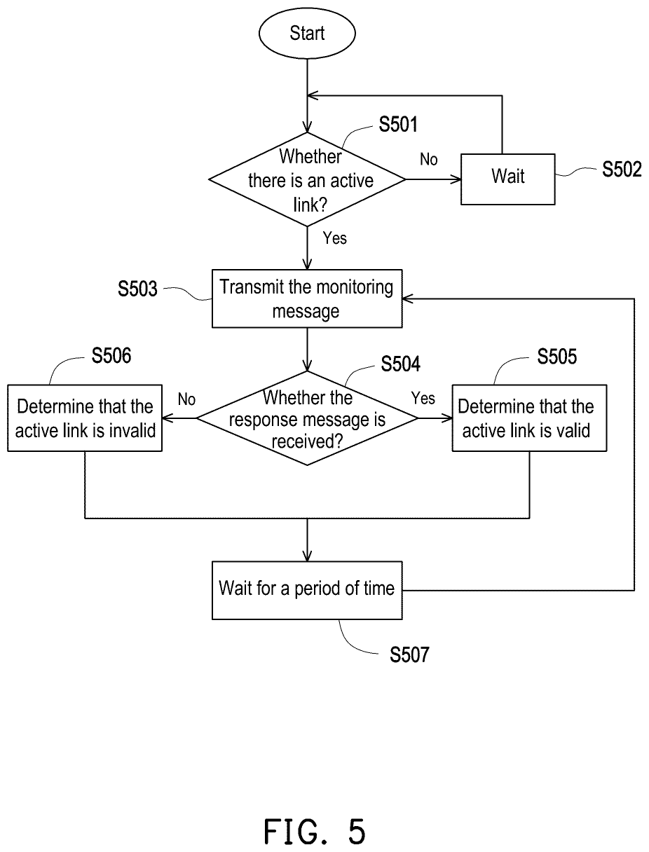

FIG. 5 is a flowchart of link validity detection according to an embodiment of the disclosure. In step S501, the unmanned device 200 (e.g., the device interface manager 222) may determine whether there is an active link (for example, determine whether there is a network card of an active transceiver 230). If there is an active link, then step S503 is performed. If there is no active link, then step S502 is performed.

In step S502, the unmanned device 200 (e.g., the device interface manager 222) may wait for a period of time, then perform step S501 again.

In step S503, the unmanned device 200 (e.g., the device interface manager 222) may transmit a monitoring message to the controller 100 through the active link, and the process proceeds to step S504, where the device interface manager 222 prepares to receive a response message corresponding to the monitoring message from the controller 100.

In step S504, the unmanned device 200 (e.g., the device interface manager 222) may determine whether the response message is received. If the device interface manager 222 receives the response message, then step S505 is performed. If the device interface manager 222 does not receive the response message, then step S506 is performed. In an embodiment, the device interface manager 222 may determine whether the response message is not received within a preset period after the monitoring message is transmitted. If the device interface manager 222 receives the response message within the preset period, then step S505 is performed. If the device interface manager 222 does not receive the response message within the preset period, then step S506 is performed. In an embodiment, the controller 100 may transmit the response message to the unmanned device 200 through the active link in response to receiving the monitoring message.

In step S505, the unmanned device 200 (e.g., the device interface manager 222) may determine that the active link is valid.

In step S506, the unmanned device 200 (e.g., the device interface manager 222) may determine that the active link is invalid.

After step S505 or step S506, step S507 is performed. In step S507, the unmanned device 200 (e.g., the device interface manager 222) may wait for a period of time, and may perform step S503 again after waiting for a period of time. That is, the device interface manager 222 may periodically perform steps S503 to S506 for the active link.

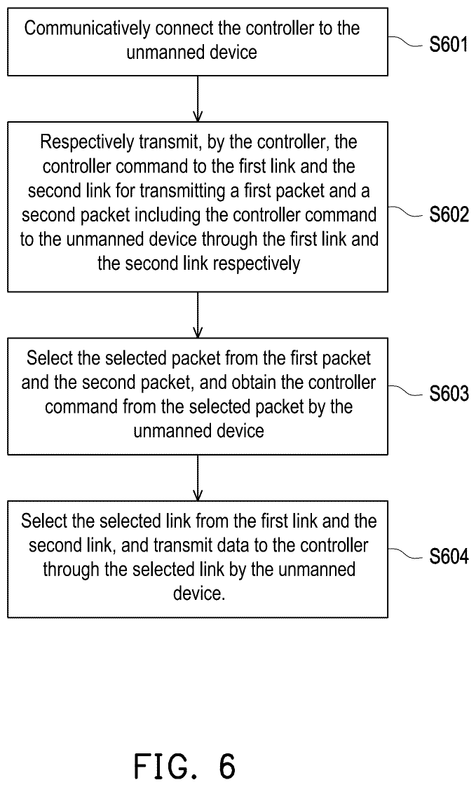

FIG. 6 is a flowchart of a communication method for an unmanned device according to an embodiment of the disclosure. The communication method may be implemented by the communication system 10 as shown in FIG. 1. In step S601, the controller is communicatively connected to the unmanned device. In step S602, a controller command is respectively transmitted by the controller to the first link and the second link (e.g., at least two link) for transmitting a first packet and a second packet including the controller command to the unmanned device through the first link and the second link respectively. In step S603, a selected packet is selected from the first packet and the second packet, and the controller command is obtained from the selected packet by the unmanned device. In step S604, a selected link is selected from the first link and the second link, and data is transmitted to the controller through the selected link by the unmanned device.

In summary, the controller of the disclosure may respectively transmit a controller command to the unmanned device through multiple links, providing redundancy effect for the communication between the controller and the unmanned device, and avoiding data loss due to single link failure. After receiving multiple packets from multiple links respectively, the unmanned device may select a selected packet from the multiple packets, and operate according to the command of the selected packet. On the other hand, since the unmanned device needs to upload a larger amount of data (for example, image data), in order to avoid excessive consumption of wireless communication resources and reduce the computational resources required for the application layer to determine data timing, the unmanned device may select a single link from multiple links, and upload data to the controller through the selected link. When the selected link fails, the unmanned device may select other links to complete the data upload that has not yet been executed, thereby achieving redundancy effect. The communication device of the disclosure may achieve uninterrupted transmission effect when switching links. The application layer of the unmanned device or controller does not need additional design for the link switching function. The disclosure may enable the communication system to manipulate the unmanned device or update the status of the unmanned device in real time, and may improve the adaptability of the communication system to environmental interference.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A communication system for an unmanned device, comprising:
an unmanned device; and
a controller, communicatively connected to the unmanned device, wherein the controller respectively transmits a controller command to a first link and a second link for transmitting a first packet and a second packet comprising the controller command to the unmanned device through the first link and the second link respectively,
the unmanned device selects a selected packet from the first packet and the second packet, and obtains the controller command from the selected packet, and
the unmanned device selects a selected link from the first link and the second link, and the unmanned device transmits data to the controller through the selected link.

2. The communication system according to claim 1, wherein
the unmanned device assigns a virtual medium access control address to the selected packet, and uploads the selected packet with the virtual medium access control address to an application layer of the unmanned device, and the application layer of the unmanned device determines a source of the selected packet according to the virtual medium access control address.

3. The communication system according to claim 2, wherein
the unmanned device determines whether the first link is valid, and determines whether a first priority of the first link is higher than a second priority of the second link, and in response to the first priority being higher than the second priority and the first link being valid, the unmanned device selects the first link as the selected link.

4. The communication system according to claim 3, wherein
the unmanned device periodically transmits a monitoring message to the controller through the first link, and receives a response message corresponding to the monitoring message from the controller, and
the unmanned device determines that the first link is valid according to the response message.

5. The communication system according to claim 3, wherein
the unmanned device determines whether the second link is valid; and
in response to the first link being invalid and the second link being valid, the unmanned device selects the second link as the selected link.

6. The communication system according to claim 1, wherein the first link is the selected link,
in response to the first link being the selected link, the unmanned device determines whether the first link is valid, and
in response to the first link being valid, the unmanned device maintains the first link as the selected link.

7. The communication system according to claim 6, wherein
the unmanned device determines whether the second link is valid, and
in response to the first link being invalid and the second link being valid, the unmanned device switches the selected link from the first link to the second link.

8. A communication method for an unmanned device, comprising:
communicatively connecting a controller to an unmanned device;
respectively transmitting, by the controller, a controller command to a first link and a second link for transmitting a first packet and a second packet comprising the controller command to the unmanned device through the first link and the second link respectively;
selecting a selected packet from the first packet and the second packet, and obtaining the controller command from the selected packet by the unmanned device; and
selecting a selected link from the first link and the second link, and transmitting data to the controller through the selected link by the unmanned device.

9. The communication method according to claim 8, further comprising:
assigning a virtual medium access control address to the selected packet, and uploading the selected packet with the virtual medium access control address to an application layer of the unmanned device by the unmanned device, wherein the application layer of the unmanned device determines a source of the selected packet according to the virtual medium access control address.

10. The communication method according to claim 9, wherein the step of selecting the selected link from the first link and the second link comprises:
determining whether the first link is valid, and determining whether a first priority of the first link is higher than a second priority of the second link by the unmanned device; and
in response to the first priority being higher than the second priority and the first link being valid, selecting the first link as the selected link by the unmanned device.

11. The communication method according to claim 10, wherein the step of determining whether the first link is valid comprises:
periodically transmitting a monitoring message to the controller through the first link, and receiving a response message corresponding to the monitoring message from the controller by the unmanned device; and
determining that the first link is valid according to the response message by the unmanned device.

12. The communication method according to claim 11, wherein the step of selecting the selected link from the first link and the second link further comprises:
in response to the first link being invalid and the second link being valid, selecting the second link as the selected link by the unmanned device.

13. The communication method according to claim 8, wherein the first link is the selected link, and the communication method further comprises:
in response to the first link being the selected link, determining whether the first link is valid by the unmanned device; and
in response to the first link being valid, maintaining the first link as the selected link by the unmanned device.

14. The communication method according to claim 13, further comprising:
determining whether the second link is valid by the unmanned device; and
in response to the first link being invalid and the second link being valid, switching the selected link from the first link to the second link by the unmanned device.
